(19) United States
(12) Patent Application Publication
(10) Pub. No.: US 2004/0065527 A1
(43) Pub. Date: Apr. 8, 2004

(54) Conveyor system method and apparatus

(75) Inventor: Barry J. Opdahl, Williamsport, PA (US)

Correspondence Address: BAKER & HOSTETLER LLP, Washington Square, Suite 1100, 1050 Connecticut Avenue, N.W., WASHINGTON, DC, 20036, US

(73) Assignee: Lunaire Limited (PA Corp)

(21) Appl. No.: 10/265,410

(22) Filed: Oct. 7, 2002

(51) Int. Cl. B65G 19/00

(52) U.S. Cl. 198/468.1

(57) ABSTRACT

A conveyor apparatus has a first lane that includes a drive mechanism that employs at least one movable vertical finger or tab. The apparatus also includes a second lane which includes a second drive mechanism that employs at least one movable vertical finger or tab. The first and second lanes are connected by a shuttle.

### FIELD OF THE INVENTION

The present invention relates to a method and apparatus for an indexing conveyor system. More particularly, the present invention relates to an indexing conveyor system that can be used for continuous ovens and furnaces.

### BACKGROUND OF THE INVENTION

The manufacturing process of many products is often a multi-step process that sometimes includes a heat treatment step. For example, the manufacturing of ceramic items or parts requires a baking or firing step and, in addition, heat treatment is used to artificially age parts or items. Furthermore, heat treatment is utilized to bake coatings that have been applied to parts or items.

Current manufacturing processes employ continuous furnaces and/or ovens to carry out the heat treatment step of the manufacturing process. Typically, the furnaces include a furnace body associated with an entry or loading station, a heating section, a cooling section, and an exit or unloading station along with a conveyor assembly. The conveyor assembly is usually continuous, propelling the product from the loading station to the furnace or oven and from the furnace or oven to the offloading station. Current conveyor assemblies include lanes upon which the products travel to and from the various stages of the furnace assembly. These lanes usually employ rails, conveyor belts and/or roller chains to propel the product to the various stages of the furnace or oven.

During operation, the product to be heat treated is loaded onto a lane of the conveyor assembly at the loading station and it is then carried to the furnace. The conveyer assembly operates to carry the items or products to be heated from a loading section to the furnace body, through the heating section and through the cooling section to the unloading station where it is eventually unloaded. Oftentimes it is desirable to reverse the direction of the product pathway in the heating chamber so that the product may be both loaded and unloaded from a single station at the same end of the furnace or oven assembly. In this arrangement, the station will most likely include an entry lane for those products entering the furnace and an exit lane, for those products coming from the furnace. This arrangement is often preferred because it provides cost savings by limiting the amount of manpower required to operate such furnaces along with making the operation of such furnaces more efficient. Current methods employed to provide single station loading and unloading include serpentine style conveyor assemblies and closed-loop style conveyor assemblies.

While the aforementioned conveyor assembly designs have operated with varying degrees of success, drawbacks exist which detract from their usefulness. For example, the serpentine and closed-loop designs require minimum turning radiuses between the entry and exit lanes in order for the products to be loaded and subsequently unloaded from a single station on the sane side of the furnace. Wasted space between the respective lanes results from these turning radiuses, increasing the required footprint of the furnace assembly. This is a drawback to the serpentine and closed-loop designs because oftentimes furnace assemblies cannot be readily integrated in production lines or assembly lines because they have a high space requirement and the addition of the serpentine or closed-loop design increases the furnace footprint.

In addition, the closed-loop and serpentine configurations require an empty section of belting or chain between the unloading station and the loading station, again adding to the furnace's footprint. Therefore, the addition of a serpentine or closed-loop design exacerbates the aforementioned problem of furnaces or ovens consuming large amounts of space on assembly lines. Furthermore, the closed-loop and serpentine configurations require and utilize multiple items that are complex in nature, significantly increasing the price of the cost of manufacture and maintenance of furnaces or ovens that employ serpentine or closed-loop conveyor configurations.

Accordingly, it is desirable to provide a method and apparatus for a continuous conveyor assembly that effectuates a continuous supply of product to and from a furnace or oven, wherein the product can be loaded and unloaded from a single station. Furthermore, it is desirable to provide a method and apparatus for a continuous conveyor assembly that allows for the loading and the unloading of product at a single station, wherein the conveyor assembly eliminates at least to some extent the wasted space between transfer lanes, and/or reduces at least to some extent the number and complexity of system components.

### SUMMARY OF THE INVENTION

The foregoing needs are met, at least in part, by the present invention where, in one aspect, a conveyor apparatus for conveying at least one item is provided for use with a furnace and/or oven. The conveyor apparatus includes a first lane which has a first drive mechanism that includes at least a first movable vertical finger or tab disposed therein. The conveyor apparatus also includes a second lane that has a second drive mechanism having at least a second movable vertical finger or tab disposed therein.

In another aspect of the invention, a conveyor apparatus for conveying at least one item is provided for use with a furnace and/or oven. The conveyor apparatus has a first lane that includes a first drive mechanism and second lane that includes a second drive mechanism. The apparatus also has a shuttle that moves items between the first and second lanes.

In yet another aspect of the invention, a conveyor apparatus for conveying an item is provided having a first means for supporting the item in a first lane and a second means for supporting the item in a second lane. The first means for supporting the item includes a driving means having at least one movable first vertical finger disposed on the supporting means. The second means for supporting the item includes a second means for driving the item having at least one movable vertical finger disposed within the second supporting means.

In yet another aspect of the invention, a method is provided for conveying an item through a lane, comprising: supporting the item in a path with at least two adjacent rails; and reciprocating a bar to move at least one vertical tab, wherein said vertical tab propels the item through the lane.

There has thus been outlined, rather broadly, several features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of an indexing conveyor system for continuous ovens and furnaces in an initial position in accordance with an embodiment of the present invention.

FIG. 2 is a perspective view of the indexing conveyor system depicted in FIG. 1 in mid-stroke of the first extend stroke position.

FIG. 3 is a perspective view of the indexing conveyor system depicted in FIGS. 1 and 2 at the end of a stroke in the first extend stroke position.

FIG. 4 is a perspective view of the indexing conveyor system depicted in FIGS. 1-3 at the end of a stroke in the first retract stroke position.

FIG. 5 is a perspective view of the indexing conveyor system depicted in FIGS. 1-4 illustrating the shuttle being translated.

FIG. 6 is a perspective view of the indexing conveyor system depicted in FIGS. 1-5 in mid-stroke of the second extend stroke position.

FIG. 7 is a perspective view of the indexing conveyor system depicted in FIGS. 1-6 at the end of a stroke in the second extend stroke position.

FIG. 8 is a perspective view of the indexing conveyor system depicted in FIGS. 1-7 at the end of a stroke in the second retract stroke position.

FIG. 9 is a perspective view of the indexing conveyor system depicted in FIGS. 1-8 illustrating the shuttle and reciprocating bars returning to their original positions as shown in FIG. 1.

### DETAILED DESCRIPTION OF PREFERRED EMBODIMENTS OF THE INVENTION

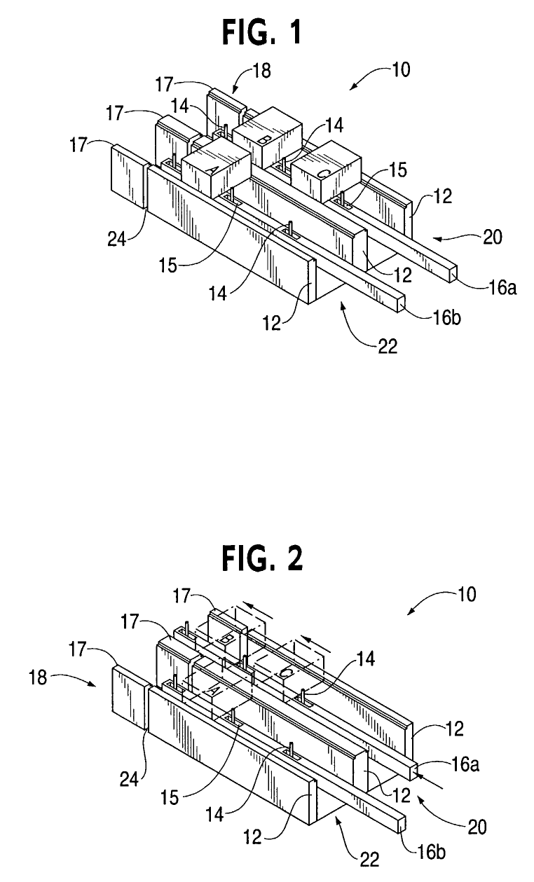

Referring now to the figures wherein like reference numerals indicate like elements, FIGS. 1-9 illustrate the presently preferred embodiments of an indexing conveyor apparatus for continuous ovens and furnaces. While in the embodiments depicted the conveyor apparatus is used in combination with a furnace or oven, it should be understood that the present invention is not limited in its application to ovens and furnaces, but, for example, can be used with other assemblies and/or apparatuses that employ conveyor systems.

Referring now to FIG. 1, an indexing conveyor apparatus for a continuous oven or furnace, generally designated 10, is illustrated. The apparatus includes a plurality of parallel rails or tracks 12, a series of vertical fingers and/or tabs 14, a plurality of reciprocating bars 16a and 16b each having a plurality of slots 15 and a shuttle 18.

The parallel rails or tracks 12 function to support and guide the items or products to be heated, generally designated A, B, C, from the loading/unloading station (not pictured), to the oven or furnace (not pictured), through the heating chamber, and back to the loading/unloading station. The items to be heated slide along the rails 12, propelled by the series of vertical fingers and/or tabs 14. The fingers and/or tabs 14, are moved or deflected by the reciprocating bars 16a, 16b which are disposed between the rails or tracks 12. As the name suggests, the reciprocating bars 16a, 16b translate in a back and forth direction and when the bars 16a, 16b are translated in a first direction, the fingers and/or tabs 14 pass freely under the parts being propelled on the rails 12. Alternatively, when the reciprocating bars are translated in a second, opposite direction, the fingers and/or tabs 14 propel the parts forward. Each full cycle of the reciprocating bars 16a, 16b propels or indexes the parts to the next position on the rails where the next vertical finger 14 will engage the product and proceed to propel the product to the next position. This movement from vertical finger 14 to vertical finger 14 is referred to as indexing.

Preferably, the vertical finger and/or tab 14 is a pawl. In the embodiments depicted, the fingers are inserted into the slots 15 on the reciprocating bars 16a, 16b, and are connected by a pivot connection. The aforementioned pivot connection allows the fingers 14 to deflect or move in the forward direction but prevents them from deflecting in the backward direction. The fingers and/or tabs 14 are biased towards a vertical position, preferably by a biasing member such as a spring or by gravity wherein the lower end of the finger 14 hereafter the pivot point has larger mass than the upper end. Alternatively, the fingers 14 can be resilient vertically cantilevered posts, that flex when pushed by the bars 16a, 16b. Accordingly, pivoting and flexing movements (also referred to as deflexitiers) can be used. By forward direction it is understood that the forward direction with respect to the loading lane 16a is direction toward the shuttle 18. With regard to the unloading lane 16b, it is understood that the forward direction is the direction toward the unloading/loading station.

As illustrated in FIGS. 1-9, the rails or tracks 12 may be utilized in pairs, each pair forming a lane 20 and 22, for supporting and guiding one column of items. It should be understood that the structures shown throughout the remainder of the figures and described herein are representative examples of embodiments in accordance with the present invention, and the invention is not limited to the structures shown and described. For example, the right lane, generally designated 20, is utilized to support and guide the parts from the loading/unloading station to the furnace or oven. The left lane, generally designated 22, is the return lane in this example, where the parts return to the loading and unloading station after their heat treatment. In the embodiments depicted, the rails are wide enough that the adjacent lanes may share rails 12, reducing the footprint of the apparatus 10. In addition, the vertical fingers and/or tabs 14 are arranged such that the adjacent lanes 20 and 22 propel the parts in opposite directions as the reciprocating bars 16 translate, providing apparatus 10 with a small footprint along with single station loading and unloading.

The apparatus 10 is not limited to two lanes and can employ more lanes depending on the application. In addition, the apparatus does not require the number of loading lanes and unloading lanes to be equivalent. For example, the heating zone within the oven may employ twelve lanes, the cooling zone six lanes and the unloading zone one lane. In these examples, the shuttle can be loaded with multiple parts in one operation from a first multi-lane conveyor, and then transfer the parts, one at a time, onto a second, single lane conveyor. Multiple translations of the shuttle then align successive shuttle lanes with the receiving conveyor lane, transferring a single part for the shuttle with each translation. Similarly, a first single lane conveyor can successively load a multi-lane shuttle, which then translates into alignment with a second multi-lane conveyor, and then the parts can then proceed to be all transferred from the shuttle onto a the second conveyor in a single operation.

As depicted in FIGS. 1-9, at the end of each lane or rail 12 is an additional set of short mating rails 17. The mating rails 17 are separated from the lanes 12 preferably by a gap 24, are mounted on a common plate (not pictured) and are collectively designated the shuttle 18. The shuttle 18 translates generally perpendicular to the to reciprocating bars 16. As each item is propelled along the loading lane 20, it is eventually transferred onto the shuttle 18 where the shuttle functions to propel the part sideways, or perpendicular to the line 20, bringing the part into alignment with the unloading lane 22 and transferring the item to the unloading lane 22. The shuttle 18 therefore eliminates the need for the aforementioned serpentine and or closed-loop designs, providing in some embodiments a very compact, single-file conveyor apparatus.

As previously described, the shuttle 18 depicted in FIGS. 1-9 includes three mating rails 17 that combine to form two lanes that compliment the loading and unloading lanes, 20 and 22, respectively. In addition, the shuttle 18 is depicted transferring one item at a time. However, the amount of lanes the shuttle may employ and amount of items the shuttle can transfer can be significantly greater than depicted. For example, embodiments of the conveyor apparatus 10 having a plurality of loading and unloading lanes may employ a shuttle 18 having multiple lanes wherein each individual lane moves multiple items.

During operation, the apparatus 10 starts in the initial position depicted in FIG. 1 and proceeds to a first extend stroke position as depicted in FIG. 2 FIG. 2 illustrates the apparatus 10 in mid-stroke of the first extend stroke position. By first extend stroke position it is understood that the reciprocating bar 16a is being translated toward the shuttle 18. In the example depicted, the vertical fingers and/or tabs 14 do not deflect in this direction and therefore as a result, the products B and C are propelled forward one index position. Product B is propelled across the gap 24 and product C is propelled to the next index position vacated by product B.

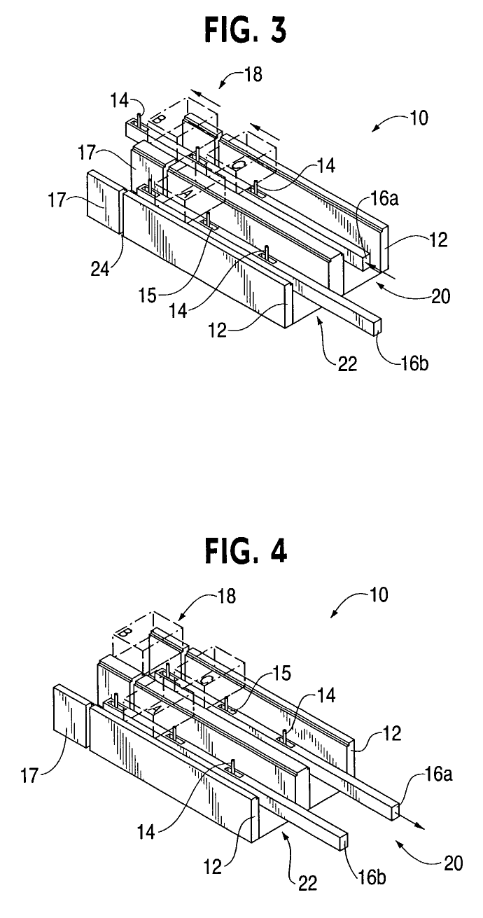

As the apparatus remains in the first extend stroke position, the reciprocating bar 16a continues to translate toward the shuttle 18 where it arrives at the end stroke position illustrated in FIG. 3. At the end stroke of the first extend stroke position, product B is now aligned on the shuttle 18 and reciprocating bar 16a has translated the maximum forward distance.

Referring now to FIG. 4, the first retract stroke position is depicted. FIG. 4 illustrates the apparatus 10 in end stroke of the first retract stroke position. By retract stroke position it is understood that the reciprocating bar 16a has been completely retracted or has translated the maximum distance opposite the shuttle 18 direction, allowing the shuttle to now translate in a direction perpendicular thereto. As the bar 16a translates in this direction, the fingers and/or tabs 14 deflect, passing freely under products B and C, leaving the products in their current resting position.

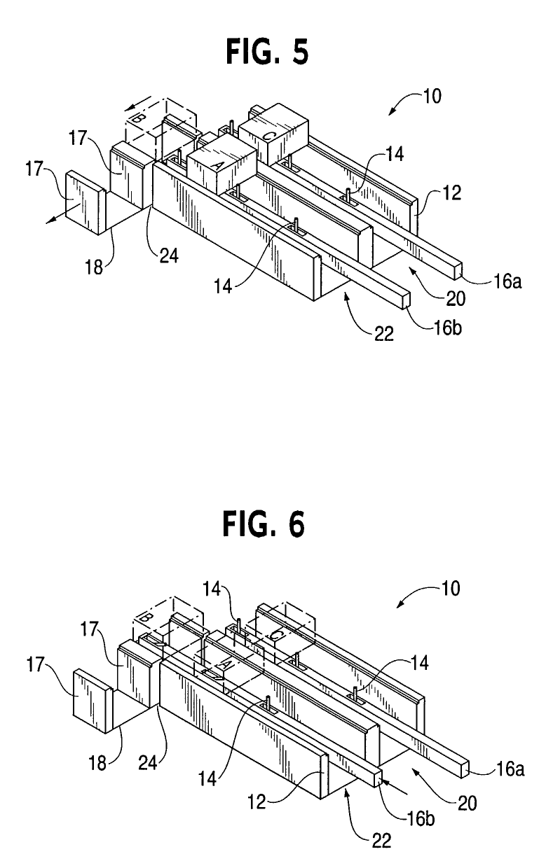

FIG. 5 shows the shuttle translating in a direction perpendicular to the rails 12 such that the product B is transferred to and aligned with the unloading lane 16b from the loading lane 16a.

Once the shuttle 18 has stopped translating, reciprocating bar 16b translates to the extend stroke position depicted in FIG. 6. FIG. 6 illustrates the apparatus 10 in mid-stroke of the aforementioned position. By second extend stroke position it is understood that reciprocating bar 16b is translating forward, towards the shuttle 18. In this direction, the fingers and/or tabs 14 deflect, passing freely under products B and C leaving the products in the current resting position. The reciprocating bar 16b continues to translate, until it reaches the maximum forward translational distance which is the end stroke of the second extend stroke.

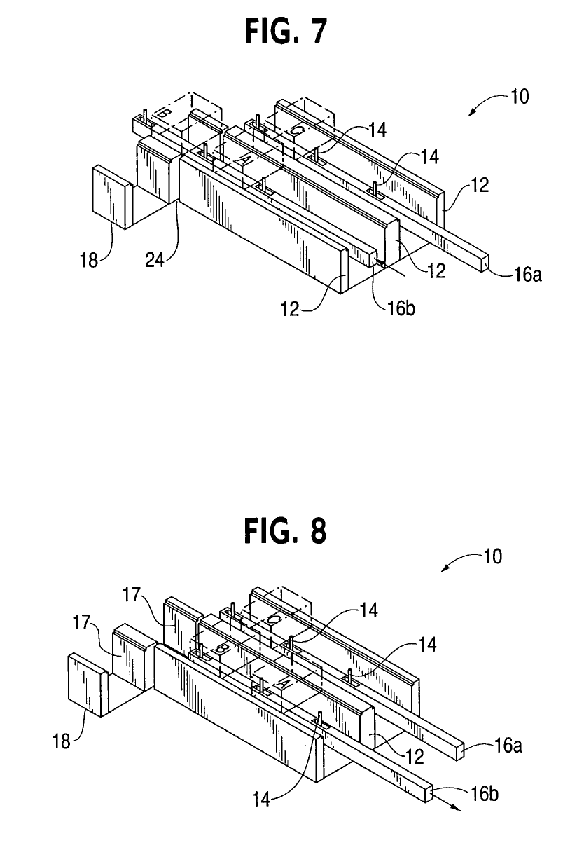

The end stroke of the second extend stroke is illustrated in FIG. 7. In this position, the fingers and/or tabs 14 have passed freely under the products A and B, and the fingers and/or tabs 14 have returned to the upward, vertical orientation.

FIG. 8 shows the apparatus 10 in the second retract stroke position. By second retract stroke position it is understood that the reciprocating bar 16b has been completely retracted or has translated the maximum distance opposite the shuttle 18 direction, allowing the shuttle to now translate in a direction perpendicular thereto and return to its original position. The fingers and/or tabs 14 do not deflect in this direction therefore during translation, both blocks A and B are propelled down the unloading lane 22 one index position.

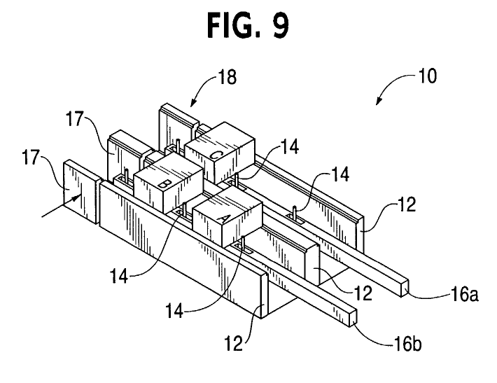

FIG. 9 shows the conveyor apparatus 10 in its original position as depicted in FIG. 1 with both bars retracted away from the shuttle 18 with the shuttle aligned with both lanes 20, 22. The conveyor apparatus is now prepared to repeat steps 19.

The embodiment described above and depicted in FIGS. 1-9 is only one possible configuration. For example, alternative embodiments may employ loops (one loop for each lane) of roller chain with tabs or fingers and/or tabs positioned at designated links instead of reciprocating bars as previously described. Similar to the above described embodiment, the tabs propel the product along the lanes each instance the chain is advanced one index position. The utilization of the chain eliminates the need for the tabs to ratchet. Instead, the tabs disengage form the parts near the shuttle and the chain goes over a sprocket. The chain then returns below the product level and the tabs come back up at the other end of the conveyor to engage another part.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A conveyor apparatus for conveying at least one item comprising:
a first lane having a first drive mechanism therein that includes at least a first movable vertical tab; and
a second lane having a second drive mechanism therein that includes at least a second movable vertical tab.

2. The apparatus according to claim 1, wherein said first lane and said second lane comprise fixed rails.

3. The apparatus according to claim 1, wherein said drive mechanisms each comprising a reciprocating bar.

4. The apparatus according to claim 1, wherein said drive mechanisms each comprising a roller chain.

5. The apparatus according to claim 1, wherein said first vertical tab of said first lane deflects in a first direction and wherein said second vertical tab of said second lane deflects in a second direction.

6. The apparatus according to claim 1, further comprising a shuttle that moves the item between said first lane and said second lane.

7. The apparatus according to claim 6, wherein said shuttle translates generally perpendicular to a direction of said first lane and said second lane.

8. The apparatus according to claim 1, wherein said first and second lanes are parallel to one another.

9. The apparatus according to claim 1, further comprising a plurality of additional lanes adjacent said first lane and said second lane.

10. The apparatus according to claim 1, further comprising a plurality of movable vertical tabs connected to each drive mechanism.

11. A conveyor apparatus for conveying at least one item comprising:
a first lane having a first drive mechanism therein;
a second lane having a second drive mechanism therein; and
a shuttle, wherein said shuttle moves the item between said first lane and said second lane.

12. The apparatus according to claim 11, wherein said first lane and said second lane include fixed rails.

13. The apparatus according to claim 11, wherein said first and said second drive mechanism each comprise a reciprocating bar.

14. The apparatus according to claim 11, wherein said first and said second drive mechanism each comprises a roller chain.

15. The apparatus according to claim 11, wherein said shuttle translates generally perpendicular to a direction of said first lane and said second lane.

16. The apparatus according to claim 11, wherein each said drive mechanism further comprises at least one movable vertical tab.

17. The apparatus according to claim 16, wherein said vertical tab of said first lane deflects in a first direction and wherein said vertical tab of said second lane deflects in a second direction.

18. The apparatus according to claim 11, wherein said first and second lanes are parallel to one another.

19. The apparatus according to claim 11, further comprising a plurality of additional lanes adjacent to said first lane and said second lane.

20. A method for conveying an item through a first lane, comprising:
supporting the item with at least two adjacent rails; and
reciprocating a bar to move at least one vertical tab, wherein said vertical tab propels the item through the lane.

21. The method according to claim 20, further comprising the step of moving the item from the first lane to a second parallel lane using a shuttle that moves generally perpendicular to the lanes.

22. A conveyor apparatus for conveying at least one item, comprising:
first means for supporting the item in a first lane;
second means for supporting the item in a second lane;
first means for driving the item using at least one movable first vertical tab disposed within said first supporting means; and
second means for driving the item with at least one movable second vertical tab disposed within said second supporting means.

23. The conveyor apparatus according to claim 22, further comprising means for moving the item from the first lane to the second lane with a shuttle that moves generally perpendicular to the direction of the lanes.
